(19) United States
(12) Patent Application Publication
(10) Pub. No.: US 2023/0337211 A1
(43) Pub. Date: Oct. 19, 2023

(54) SPS HARQ-ACK PROCESSING METHOD AND APPARATUS, DEVICE, AND READABLE STORAGE MEDIUM

(71) Applicant: VIVO MOBILE COMMUNICATION CO., LTD., Dongguan (CN)

(72) Inventors: Chaojun ZENG, Dongguan (CN); Na LI, Dongguan (CN); Xiaohang CHEN, Dongguan (CN)

(73) Assignee: VIVO MOBILE COMMUNICATION CO., LTD., Dongguan (CN)

(21) Appl. No.: 18/212,171

(22) Filed: Jun. 20, 2023

Related U.S. Application Data
(63) Continuation of application No. PCT/CN2021/140399, filed on Dec. 22, 2021.

(30) Foreign Application Priority Data
Dec. 22, 2020 (CN) 202011528259.5

(51) Int. Cl. H04W 72/11; H04L 1/1812; H04W 72/21; H04W 72/1273; H04L 5/14

(52) U.S. Cl. CPC H04W 72/11; H04L 1/1812; H04W 72/21; H04W 72/1273; H04L 5/1469

(57) ABSTRACT

A Semi-Persistent Scheduling (SPS) Hybrid Automatic Repeat reQuest ACKnowledgement (HARQ-ACK) processing method and apparatus, a device, and a readable storage medium are provided. The method includes: determining whether a first Physical Uplink Control Channel (PUCCH) resource exists; and transmitting a first SPS HARQ-ACK based on the first PUCCH resource if the first PUCCH resource exists. The first SPS HARQ-ACK includes at least a delayed SPS HARQ-ACK.

### CROSS-REFERENCE TO RELATED APPLICATIONS

This application is a continuation of International Application No. PCT/CN2021/140399, filed on Dec. 22, 2021, which claims priority to Chinese Patent Application No. 202011528259.5, filed on Dec. 22, 2020, The entire contents of each of the above-referenced applications are expressly incorporated herein by reference.

### TECHNICAL FIELD

This application pertains to the field of communication technologies, and specifically relates to a Semi-Persistent Scheduling (SPS) Hybrid Automatic Repeat reQuest ACKnowledgement (HARQ-ACK) processing method and apparatus, a device, and a readable storage medium.

### BACKGROUND

A symbol conflict in a Time Division Duplex (TDD) system causes discarding of an SPS HARQ-ACK. The SPS HARQ-ACK may be understood as a HARQ-ACK feedback for an SPS Physical Downlink Shared Channel (PDSCH). A larger proportion of downlink or flexible symbols configured in a frame structure indicates a higher probability of such a conflict. In a case that a network side fails to receive the SPS HARQ-ACK, the network side can only perform blind scheduling for the corresponding SPS PDSCH. This reduces system efficiency. In another case, the network side abandons the corresponding SPS PDSCH. This results in a high residual packet error rate, and severely affects transmission performance in a communication system.

### SUMMARY

Embodiments of this application provide an SPS HARQ-ACK processing method and apparatus, a device, and a readable storage medium.

According to a first aspect, an SPS HARQ-ACK processing method is provided, performed by a terminal and including:

determining whether a first Physical Uplink Control Channel (PUCCH) resource exists; and

sending a first SPS HARQ-ACK based on the first PUCCH resource if the first PUCCH resource exists, where the first SPS HARQ-ACK includes at least a delayed SPS HARQ-ACK

According to a second aspect, an SPS HARQ-ACK processing method is provided, performed by a network side device and including:

determining whether a first PUCCH resource exists; and

receiving a first SPS HARQ-ACK based on the first PUCCH resource if the first PUCCH resource exists, where the first SPS HARQ-ACK includes at least a delayed SPS HARQ-ACK.

According to a third aspect, an embodiment of this application provides an SPS HARQ-ACK processing apparatus, including:

a first determining module, configured to determine whether a first PUCCH resource exists; and

a first sending module, configured to send a first SPS HARQ-ACK based on the first PUCCH resource if the first PUCCH resource exists, where the first SPS HARQ-ACK includes at least a delayed SPS HARQ-ACK.

According to a fourth aspect, an SPS HARQ-ACK processing apparatus is provided, including:

a second determining module, configured to determine whether a first PUCCH resource exists; and

a first receiving module, configured to receive a first SPS HARQ-ACK based on the first PUCCH resource if the first PUCCH resource exists, where the first SPS HARQ-ACK includes at least a delayed SPS HARQ-ACK.

According to a fifth aspect, a terminal is provided, including a processor, a memory, and a program that is stored in the memory and that can be run on the processor. When the program is executed by the processor, steps of the method according to the first aspect are implemented.

According to a sixth aspect, a network side device is provided, including a processor, a memory, and a program that is stored in the memory and that can be run on the processor. When the program is executed by the processor, steps of the method according to the second aspect are implemented.

According to a seventh aspect, a readable storage medium is provided. The readable storage medium stores a program or instructions, and when the program or the instructions is/are executed by a processor, steps of the method according to the first aspect or the second aspect are implemented.

According to an eighth aspect; a program product is provided. The program product is stored in a non-volatile storage medium, and the program product is executed by at least one processor to implement steps of the method according to the first aspect or the second aspect.

According to a ninth aspect, a chip is provided. The chip includes a processor and a communication interface. The communication interface is coupled to the processor, and the processor is configured to run a program or instructions to implement the method according to the first aspect or the second aspect.

According to a tenth aspect, an embodiment of this application provides a communication device, configured to perform steps of the method according to the first aspect or configured to perform steps of the method according to the second aspect.

In embodiments of this application, the terminal may send the delayed SPS HARQ-ACK by using the first PUCCH resource, and the network side device may receive the delayed SPS HARQ-ACK by using the first PUCCH resource. This avoids a case that a network side cannot receive an SPS HARQ-ACK and improves reliability of a communication system.

### BRIEF DESCRIPTION OF THE DRAWINGS

FIG. 1 is a schematic diagram of a wireless communication system according to an embodiment of this application;

FIG. 2 is a flowchart 1 of an SPS HARQ-ACK processing method according to an embodiment of this application;

FIG. 3 is a flowchart 2 of an SPS HARQ-ACK processing method according to an embodiment of this application;

FIG. 4 shows an SPS HARQ-ACK processing apparatus 1 according to an embodiment of this application;

FIG. 5 shows an SPS HARQ-ACK processing apparatus 2 according to an embodiment of this application;

FIG. 6 is a schematic diagram of a terminal according to an embodiment of this application; and

FIG. 7 is a schematic diagram of a network side device according to an embodiment of this application.

### DETAILED DESCRIPTION

The following clearly describes the technical solutions in embodiments of this application with reference to the accompanying drawings in embodiments of this application. It is clear that the described embodiments are some rather than all of embodiments of this application. Based on embodiments of this application, all other embodiments obtained by a person of ordinary skill in the art without creative efforts fall within the protection scope of this application.

The terms “first”, “second”, and the like in the specification and claims of this application are used to distinguish between similar objects, but are not used to describe a specific sequence or order. It should be understood that data used in this way may be interchangeable in an appropriate case, so that embodiments of this application can be implemented in a sequence other than those shown or described herein, objects distinguished by “first” and “second” are generally of one type, and a quantity of objects is not limited. For example, there may be one or more first objects. In addition, in the specification and claims, “and” represents at least one of connected objects, and the character “/” generally represents an “or” relationship between associated objects.

It should be noted that the technology described in embodiments of this application is not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and another system. The terms “system” and “network” in embodiments of this application are often used interchangeably. The described technology may be used in the foregoing system and radio technology, or may be used in another system and radio technology. The following describes a New Radio (NR) system as an example, and NR terms are used in most of the following descriptions, although these technologies may also be applied to applications other than NR system applications, for example, a 6^{th} Generation (6G) communication system.

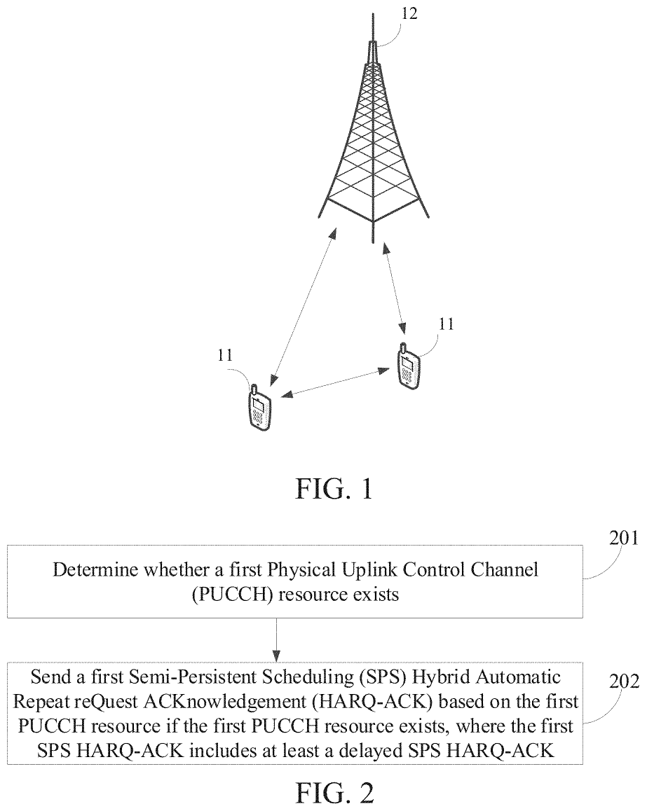

FIG. 1 is a block diagram of a wireless communication system to which an embodiment of this application is applicable. The wireless communication system includes a terminal 11 and a network side device 12. The terminal 11 may also be referred to as a terminal device or a User Equipment (UE). The terminal 11 may be a terminal side device such as a mobile phone, a tablet computer, a laptop computer or a notebook computer, a Personal Digital Assistant (PDA), a palmtop computer, a netbook, an Ultra-Mobile Personal Computer (UMPC), a Mobile Internet Device (MID), a wearable device, a Vehicle-User Equipment (VUE), or a Pedestrian User Equipment (PUE). The wearable device includes a band, a headset, glasses, or the like. It should be noted that a specific type of the terminal 11 is not limited in embodiments of this application. The network side device 12 may be a base station or a core network side device. The base station may be referred to as a NodeB, an evolved NodeB, an access point, a Base Transceiver Station (BTS), a radio base station, a radio transceiver, a Basic Service Set (BSS), an Extended Service Set (ESS), a NodeB, an evolved NodeB (eNB), a home NodeB, a home evolved NodeB, a Wireless Local Area Network (WLAN) access point, a node, a Transmission and Reception Point (TRP), or another appropriate term in the field. Provided that a same technical effect is achieved, the base station is not limited to a specified technical term. It should be noted that in embodiments of this application, only a base station in an NR system is used as an example, but a specific type of the base station is not limited.

With reference to the accompanying drawings, the following describes in detail an SPS HARQ-ACK processing method and apparatus, a device, and a readable storage medium in embodiments of this application by using some embodiments and application scenarios thereof.

As shown in FIG. 2, an embodiment of this application provides an SPS HARQ-ACK processing method. The method is performed by a terminal and includes the following steps.

Step 201: Determine whether a first PUCCH resource exists.

Step 202: Send a first SPS HARQ-ACK based on the first PUCCH resource if the first PUCCH resource exists, where the first SPS HARQ-ACK includes at least a delayed SPS HARQ-ACK

The delayed SPS HARQ-ACK in this specification may be understood as a HARQ-ACK feedback that is for an SPS PDSCH and that cannot be fed back at a predetermined time domain position due to a symbol conflict in a TDD system. If the SPS HARQ-ACK is actually, transmitted subsequently, there is a feedback delay relative to the predetermined time domain position. The predetermined time domain position herein may be determined based on an indication in SPS activation Downlink Control Information (DCI) or SPS reactivation DCI, and may be understood as being indicated in a semi-static manner.

In this embodiment of this application, the first PUCCH resource is in a first time unit.

The first time unit meets one or more of the following:

(1) a first condition, where the first condition includes: the first PUCCH resource meeting a predefined resource requirement exists in the first time unit;

(2) a second condition, where the second condition includes: an offset between the first time unit and a time unit to which a semi-persistent scheduling physical downlink shared channel SPS PDSCH transmission end moment belongs meets a predefined timing requirement; and

(3) a third condition, where the third condition includes: the first time unit is an earliest time unit in a set of time units meeting the first condition and/or the second condition.

In this embodiment of this application, a time unit may be a slot or a sub-slot

In this embodiment of this application, if the first PUCCH resource does not exist, the method further includes:

retransmitting the first SPS HARQ-ACK, or compressing or discarding the delayed SPS HARQ-ACK.

In this embodiment of this application, the retransmitting the first SPS HARQ-ACK includes:

receiving a first indication; and

retransmitting the first SPS HARQ-ACK according to the first indication.

In this embodiment of this application, the compressing or discarding the delayed SPS HARQ-ACK includes:

compressing a quantity of bits of the delayed SPS HARQ-ACK, or discarding a part of the delayed SPS HARQ-ACK, to obtain a second SPS HARQ-ACK;

determining a second PUCCH resource based on a quantity of bits of the second SPS HARQ-ACK; and

transmitting the second SPS HARQ-ACK based on the second PUCCH resource.

In this embodiment of this application, the method further includes:

determining whether an offset between a second time unit and a time unit to which an SPS PDSCH transmission end moment belongs meets a predefined timing requirement;

if the offset meets the predefined timing requirement, determining an SPS HARQ-ACK transmitted in the second time unit;

determining a PUCCH resource pool based on the SPS HARQ-ACK transmitted in the second time unit; and

selecting, from the PUCCH resource pool, the first PUCCH resource meeting a predefined resource requirement, and then performing the step of sending the first SPS HARQ-ACK based on the first PUCCH resource.

When the foregoing method is used as a processing procedure of a single cycle of a first cyclic processing process, the second time unit may be understood as a current time unit, that is, a time unit corresponding to a current single cycle of the first cyclic processing process.

in this embodiment of this application, the method further includes:

determining a PUCCH resource pool based on an SPS HARQ-ACK transmitted in a third time unit;

selecting, from the PUCCH resource pool, the first PUCCH resource meeting a predefined resource requirement;

determining whether an offset between the third time unit and a time unit to which an SPS PDSCH transmission end moment belongs meets a predefined timing requirement; and

if the offset meets the predefined timing requirement, performing the step of sending the first SPS HARQ-ACK based on the first PUCCH resource.

When the foregoing method is used as a processing procedure of a single cycle of a second cyclic processing process, the third time unit may be understood as a current time unit, that is, a time unit corresponding to a current single cycle of the second cyclic processing process.

In this embodiment of this application, the predefined timing requirement includes one or more of the following:

(1) the offset of the first time unit does not exceed a predefined maximum value; and

(2) the offset of the first time unit is a specific value in a predefined set.

In this embodiment of this application, the predefined maximum value includes any one of the following:

(1) a maximum value of K1 in a base K1 set configured by a higher layer;

(2) a TDD cycle length corresponding to a TDD pattern configured by a higher layer;

(3) a parameter independently configured by a higher layer; and

(4) a value specified in a protocol.

In this embodiment of this application, the predefined set includes any one of the following:

(1) a base K1 set;

(2) a new K1 set independently configured by a higher layer for the delayed SPS HARQ-ACK.

(3) a union set of a base K1 set and an additional K1 set that is additionally configured by a higher layer for the delayed SPS HARQ-ACK, and

(4) a set specified in a protocol.

In this embodiment of this application, the predefined resource requirement includes one or more of the following:

(1) the first PUCCH resource is in a first PUCCH resource pool;

(2) a time domain and/or a frequency domain occupied by the first PUCCH resource are/is available; and

(3) the first PUCCH resource can carry a quantity of bits of a HARQ-ACK that needs to be transmitted in a current time unit.

In this embodiment of this application, the first PUCCH resource pool includes one or more of the following:

(1) a PUCCH resource in a PUCCH resource set configured for dynamic scheduling HARQ-ACK feedback;

(2) a PUCCH resource configured for transmission of a HARQ-ACK that comprises only an SPS HARQ-ACK; and

(3) a configured PUCCH resource that can be used for SPS HARQ-ACK feedback.

In this embodiment of this application, whether the time domain and/or the frequency domain occupied by the first PUCCH resource are/is available is determined based on one or more of the following:

(1) a Radio Resource Control (RRC) semi-static configuration;

(2) a slot format indication for dynamic indication; and

(3) downlink control information.

In this embodiment of this application, if there are a plurality of PUCCH resources meeting the predefined resource requirement in the first time unit, the first PUCCH resource is determined in any one of the following manners:

(1) the first PUCCH resource is a PUCCH resource with an earliest start time or end time;

(2) the first PUCCH resource is a PUCCH resource corresponding to a first PUCCH Resource Indicator (PRI), and the first PRI is a PRI corresponding to the first SPS HARQ-ACK; and

(3) the first PUCCH resource is a PUCCH resource that can carry a largest quantity of bits.

In this embodiment of this application, when the first SPS HARQ-ACK corresponds to a plurality of PRIs, the first PRI is determined based on one or more of the following:

(1) a serving cell index;

(2) an SPS configuration index;

(3) an SPS PDSCH transmission moment; and

(4) a PUCCH resource capacity.

In this embodiment of this application, a category of a codebook including the first SPS HARQ-ACK corresponds to any one of the following:

(1) a codebook including only an SPS HARQ-ACK (SPS HARQ-ACK only);

(2) a type-1 codebook (Type-1 codebook); and

(3) a type-2 codebook (Type-2 codebook),

In this embodiment of this application, a manner for constructing the codebook (codebook) applicable to only the SPS HARQ-ACK includes:

performing a loop at each layer on a serving cell, an SPS configuration index (SPS Config index), and a Downlink slot (DL slot) in a preset order.

In this embodiment of this application, a manner for constructing the type-1 codebook includes one of the following:

(1) construction based on a base K1 set; and

(2) construction based on an extended K1 set.

In this embodiment of this application, the construction based on a base K1 set includes one of the following:

(1) adding an SPS HARQ-ACK bit sequence to a specified location of a codebook, where each HARQ-ACK bit in the SPS HARQ-ACK bit sequence is in a one-to-one correspondence with a first SPS PDSCH, and no HARQ-ACK bit corresponding to the first SPS PDSCH exists in the codebook; and

(2) adding X bits to a specified location of a codebook, where the X bits are used to store a HARQ-ACK corresponding to a first SPS PDSCH, no HARQ-ACK bit corresponding to the first SPS PDSCH exists in the codebook, that is, the HARQ-ACK corresponding to the first SPS PDSCH has no corresponding HARQ-ACK bit in the codebook, and X is a positive integer.

In this embodiment of this application, the construction based on an extended K1 set includes one of the following:

(1) Values of K1 corresponding to all SPS HARQ-ACKs that point to a time unit in which a specified type-1 codebook is reported are determined, a union set of the values of K1 and a base K1 set is Obtained and ordered, and then a codebook is constructed based on an ordered union set.

It may be understood that the base K1 set is a base K1 set configured by a higher layer, for example, a d1-DataToUL-ACK list in the new radio release 15/16.

(2) A union set of a K1 set used for SPS HARQ-ACK configuration and a base K1 set is obtained and ordered, and then a codebook is constructed based on an ordered union set.

(3) A codebook is constructed based on a K1 set used for SPS HARQ-ACK configuration.

It may be understood that the ordering described in this specification may be arrangement in descending order from small to large, or may be another arrangement manner.

(4) A first K1 set is set to including all natural numbers in 0 to a maximum value of K1, ordering is performed, and a codebook is constructed based on the first K1 set, where the maximum value of K1 is a maximum value in the base K1 set.

It may be understood that the first K1 set is a K1 set actually used when the codebook is constructed, and may be equal to or not equal to the base K1 set.

In this embodiment of this application, the delayed SPS HARQ-ACK corresponds to a first candidate PDSCH reception in the type-1 codebook, and the first candidate PDSCH reception meets:

(1) corresponding K1 is an offset between a time unit to which an end moment of a second SPS PDSCH belongs and a feedback time unit of the type-1 codebook; and

(2) a corresponding Start and Length Indicator Value (SLIV) is a SLIV corresponding to the second SPS PDSCH.

The second SPS PDSCH corresponds to the delayed SPS HARQ-ACK.

The type-1 codebook sets a HARQ-ACK bit sequence for one candidate PDSCH reception set, where each candidate PDSCH reception in the set corresponds to one or more HARQ-ACK bits in the HARQ-ACK bit sequence. The type-1 codebook may be understood as equivalent to the HARQ-ACK bit sequence.

In this embodiment of this application, the terminal may send the delayed SPS HARQ-ACK by using the first PUCCH resource. This avoids a case that a network side cannot receive an SPS HARQ-ACK, and improves reliability of a communication system.

In this embodiment of this application, if the first PUCCH resource exists, the terminal may transmit the delayed SPS HARQ-ACK by using the available first PUCCH resource. This can of effectively restore an SPS HARQ-ACK discarded due to a symbol conflict in a time division duplex system, thereby improving reliability of a communication system.

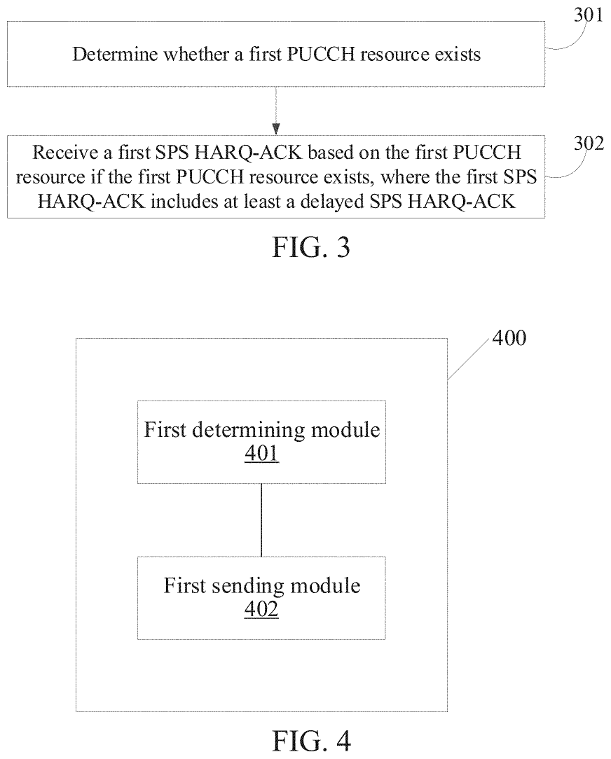

As shown in FIG. 3, an embodiment of this application provides an SPS HARQ-ACK processing method. The method is performed by a network side device and includes the following steps.

Step 301: Determine whether a first PUCCH resource exists.

Step 302: Receive a first SPS HARQ-ACK based on the first PUCCH resource if the first PUCCH resource exists, where the first SPS HARQ-ACK includes at least a delayed SPS HARQ-ACK.

In this embodiment of this application, the method further includes:

sending a first indication, where the first indication is used to indicate terminal to retransmit the first SPS HARQ-ACK.

In this embodiment of this application, the first PUCCH resource is in a first time unit.

The first time unit meets one or more of the following:

a first condition, wherein the first condition comprises: the first PUCCH resource meeting a predefined resource requirement exists in the first time unit;

a second condition, wherein the second condition comprises: an offset between the first time unit and a time unit to which a semi-persistent scheduling physical downlink shared channel SPS PDSCH transmission end moment belongs meets a predefined timing requirement; and

a third condition, wherein the third condition comprises: the first time unit is an earliest time unit in a set of time units meeting the first condition and/or the second condition.

In this embodiment of this application, the predefined timing requirement includes one or more of the following:

the offset of the first time unit does not exceed a predefined maximum value; and

the offset of the first time unit is a specific value in a predefined set.

In this embodiment of this application, the predefined maximum value includes any one of the following:

a maximum value of K1 in a base K1 set configured by a higher layer;

a TDD cycle length corresponding to a time division duplex TDD pattern Pattern configured by a higher layer;

a parameter independently configured by a higher layer; and

a value specified in a protocol.

In this embodiment of this application, the predefined set includes any one of the following:

a base K1 set;

a new K1 set independently configured by a higher layer for the delayed SPS HARQ-ACK;

a union set of a base K1 set and an additional K1 set that is additionally configured by a higher layer for the delayed SPS HARQ-ACK; and

a set specified in a protocol.

In this embodiment of this application, the predefined resource requirement includes one or more of the following:

the first PUCCH resource is in a first PUCCH resource pool;

a time domain and/or a frequency domain occupied by the first PUCCH resource are/is available; and

the first PUCCH resource can carry a quantity of bits of a HARQ-ACK that needs to be transmitted in a current time unit.

In this embodiment of this application, the first PUCCH resource pool includes one or more of the following:

a PUCCH resource in a PUCCH resource set configured for dynamic scheduling HARQ-ACK feedback;

a PUCCH resource configured for transmission of a HARQ-ACK that comprises only an SPS HARQ-ACK; and

a configured PUCCH resource that can be used for SPS HARQ-ACK feedback.

In this embodiment of this application, whether the time domain and/or the frequency domain occupied by the first PUCCH resource are/is available is determined based on one or more of the following:

an RRC semi-static configuration;

a slot format indication for dynamic indication; and

downlink control information.

In this embodiment of this application, if there are a plurality of PUCCH resources meeting the predefined resource requirement in the first time unit, the first PUCCH resource is determined in any one of the following manners:

the first PUCCH resource is a PUCCH resource with an earliest start time or end time;

the first PUCCH resource is a PUCCH resource corresponding to a first PRI, and the first PRI is a PRI corresponding to the first SPS HARQ-ACK; and

the first PUCCH resource is a PUCCH resource that can carry a largest quantity of bits.

In this embodiment of this application, when the first SPS HARQ-ACK corresponds to a plurality of PRIs, the first PRI is determined based on one or more of the following:

a serving cell index;

an SPS configuration index;

an SPS PDSCH transmission moment; and

a PUCCH resource capacity.

In this embodiment of this application, the network side device may receive the delayed SPS HARQ-ACK by using the first PUCCH resource. This avoids a case that a network side cannot receive an SPS HARQ-ACK, and improves reliability of a communication system.

It may be understood that feedback for a delayed SPS HARQ-ACK may include the following operations: (1) determining an available first PUCCH resource, and (2) constructing a codebook when a first SPS HARQ-ACK is fed back, where the first SPS HARQ-ACK includes at least the delayed SPS HARQ-ACK. The following provides detailed description.

1. Determine the first PUCCH resource.

A function that needs to be completed to determine the first PUCCH resource is: determining which first PUCCH resource in which time unit is used to carry a feedback including a delayed first SPS HARQ-ACK.

1.1. Determine a time unit.

When a time unit to which the first PUCCH resource belongs is determined, a selected first time unit needs to meet a preset condition, for example, one or more of a slot condition 1 to a slot condition 3.

Slot condition 1: The first PUCCH resource meeting a predefined resource requirement exists in the first time unit. The predefined resource requirement includes but is not limited to one or more of the following resource requirement 1 to resource requirement 3.

(a) Resource requirement 1: The first PUCCH resource is in a specified PUCCH resource pool.

(b) Resource requirement 2: A time-frequency (including a time domain and a frequency domain) occupied by the first PUCCH resource is available. In terms of time domain, whether a symbol occupied by the first PUCCH resource is available may be determined based on a rule 1 or a rule 2.

Rule 1: Determining is performed based on an RRC semi-static configuration.

The RRC semi-static configuration may include a TDD configuration (Config) and/or a Synchronization Signal and PBCH Block (SSB) configuration, an invalid symbol, and the like. An SSB transmission symbol indicated by the SSB configuration may be considered as a semi-static Downlink symbol (DL symbol).

The TDD Config may include a common Time Division Duplex Uplink-Downlink Configuration (TDD-UL-DL-ConfigCommon) and a dedicated Time Division Duplex Uplink-Downlink Configuration (TDD-UL-DL-ConfigDedicated), and may indicate three states: Uplink (UL)/Downlink (DL)/flexible, for a symbol. The following rule 1-1 or rule 1-2 may be further used.

Rule 1-1: Only a Semi-static Uplink symbol (Semi-static UL symbol) is available.

Rule 1-2: Both a Semi-static Uplink symbol (Semi-static UL symbol) and a Semi-static flexible symbol are available.

It should be noted that when a delivered. Slot Format Indication (SFI) is configured on a network, based on the SFI indication, the semi-static flexible symbol may be further indicated as a dynamic UL/DL/flexible symbol. For a semi-static flexible symbol, when a delivered SFI is configured on a network side, but a terminal does not detect the SFI, or the terminal detects that the SFI further indicates the semi-static flexible symbol as a dynamic DL/flexible symbol, or the terminal detects that DCI schedules the semi-static/dynamic flexible symbol for downlink transmission (the dynamic flexible symbol herein means that the SFI first indicates the semi-static flexible symbol as the dynamic flexible symbol), transmission is actually not performed on a PUCCH resource that occupies the semi-static flexible symbol.

Therefore, when the foregoing rule 1-1 is used, it can be always ensured that the determined first PUCCH resource can be actually used for transmission, but the determined first PUCCH resource may be late, resulting in a high retransmission delay. When the foregoing rule 1-2 is used, a HARQ-ACK feedback delay is low, but the determined first PUCCH resource possibly cannot be used for transmission actually.

In some embodiments, for the rule 1-2, when a delivered SFI is configured on a network side, but a terminal does not detect the SFI, the network side may configure whether the terminal can use a semi-static flexible symbol occupied by the first PUCCH resource as an available symbol. For example, the network side configures a higher-layer parameter for the terminal to indicate whether the semi-static flexible symbol can be used for transmission on the first PUCCH resource when the terminal does not detect the SFI.

Rule 2: Determining is performed based on an RRC semi-static configuration, such as a TDD Config or an SSB, and an SFI for dynamical indication, and/or DCI.

In comparison with the rule 1, whether a symbol is available needs to be determined herein with reference to the SFI for dynamical indication at a physical layer and/or the DCI, to determine whether the entire first PUCCH resource is available.

A semi-static UL symbol is necessarily available. Whether a semi-static flexible symbol is available needs to be determined based on whether the terminal is configured to detect the SFI and a further indication of the SFI detected by the terminal for the semi-static flexible symbol. For a semi-static flexible symbol, when a delivered SFI is configured on a network side, but a terminal does not detect the SFI, or the terminal detects that the SFI further indicates the semi-static flexible symbol as a dynamic DL/flexible symbol, or the terminal detects that DCI schedules the semi-static/dynamic flexible symbol for downlink transmission (the dynamic flexible symbol herein means that the SFI first indicates the semi-static flexible symbol as the dynamic flexible symbol), the semi-static flexible symbol is determined as unavailable, and therefore, a PUCCH resource that occupies the semi-static flexible symbol is also determined as unavailable.

In some embodiments, in time domain, when a symbol occupied by a PUCCH resource overlaps some unavailable time periods, it may also be considered that the PUCCH resource is unavailable. These unavailable time periods may include an uplink-downlink conversion time, a Bandwidth Part (BWP) switching time, an unavailable time of an unlicensed frequency band (for example, an idle period in a Frame Based Equipment (FBE) mode), and the like.

In some embodiments, in frequency domain, when a resource block occupied by a PUCCH resource conflicts with transmission in RRC semi-static configuration, it may also be considered that the PUCCH resource is unavailable. For example, when a Physical Random Access Channel (PRACH), a Sounding Reference Signal (SRS), or the like is transmitted on a symbol occupied by a PUCCH resource, it may also be determined that the PUCCH resource is unavailable.

In some embodiments, when whether a conflict occurs in a HARQ-ACK feedback corresponding to an SPS PDSCH is determined, and subsequent recovery is required, the foregoing rule, that is, the rule 1 (rule 1-1 or rule 1-2) or the rule 2, may also be used to determine that all symbols occupied by PUCCH transmission corresponding to a HARQ-ACK feedback corresponding to an SPS PDSCH are available. When it is determined that at least one symbol is unavailable, the PUCCH transmission encounters a conflict. In this case, the HARQ-ACK corresponding to the SPS PDSCH needs to be discarded in the PUCCH transmission, and feedback is delayed.

(c) Resource requirement 3: The first PUCCH resource can carry a quantity of bits of a HARQ-ACK that needs to be transmitted in a current time unit.

In addition to a delayed SPS HARQ-ACK feedback, the quantity of bits of the HARQ-ACK that needs to be transmitted in the current time unit may further include an SPS HARQ-ACK that needs to be fed back in the current time unit based on timing, a dynamic scheduling HARQ-ACK feedback, and the like.

When a quantity of bits that can be carried in a PUCCH resource is considered, a PUCCH format, a PUCCH resource set or a supported bit quantity range, a quantity of occupied symbols/a maximum Physical Resource Block (PRB) quantity/a maximum bit rate, and the like need to be considered.

In some embodiments, a bundling manner may be considered to be used for a part or all of the delayed SPS HARQ-ACK to compress a quantity of HARQ-ACK bits that actually need to be transmitted, or a part of the delayed SPS HARQ-ACK may be discarded (for example, a discarding rule may be determined based on a delay time or an SPS Config index) to reduce a quantity of HARQ-ACK bits that actually need to be transmitted, and whether the PUCCH resource can carry remaining to-be-transmitted HARQ-ACK bits is determined based on a quantity of remaining to-be-transmitted HARQ-ACK bits obtained after the compression or discarding operation.

It may be understood that these to-be-transmitted HARQ-ACK bits may be further multiplexed with other Uplink Control Information (UCI) (for example, a Scheduling Request (SR) and Channel State Information (CST)).

Slot condition 2: An offset between the first time unit to which the first PUCCH resource belongs and a time unit to which an SPS PDSCH transmission end moment belongs meets a predefined timing requirement. The predefined timing requirement herein includes but is not limited to a timing requirement 1 and/or a timing requirement 2.

Timing requirement 1: The offset of the first time unit does not exceed a predefined maximum value. The predefined maximum value herein may include any one of a maximum value manner 1 to a maximum value manner 4:

maximum value manner 1: a maximum value of K1 in a base K1 set (that is, a d1-DataToUL-ACK list in NR Rel-15/16, which is referred to as a base K1 set below for short) configured by a higher layer;

maximum value manner 2: a TDD cycle length corresponding to a TDD pattern configured by a higher layer, where the TDD pattern herein may be information configured in TDD-UL-DL-ConfigCommon, and for example, includes a pattern 1 and a pattern 2;

maximum value manner 3: a parameter independently configured by a higher layer; and

maximum value manner 4: a value specified in a protocol.

Timing requirement 2: The offset of the time unit is a specific value in a predefined set. The predefined set herein may include any one of a set manner 1 to a set manner 4:

set manner 1: a base K1 set;

set manner 2: a new K1 set independently configured by a higher layer for the delayed SPS HARQ-ACK;

set manner 3: a union set of a base K1 set and an additional K1 set that is additionally configured by a higher layer for the delayed SPS HARQ-ACK; and

set manner 4: a set specified in a protocol.

Slot condition 3: An earliest time unit in a set of time units meeting one or more other slot conditions (that is, meeting the slot condition 1 or meeting both the slot condition 1 and the slot condition 2).

1.2. Select the first PUCCH resource.

When the first PUCCH resource for carrying the delayed SPS HARQ-ACK is determined, an available resource range, that is, a PUCCH resource pool, needs to be first determined, and then the first PUCCH resource is further selected from the PUCCH resource pool.

1.2.1. Determine the PUCCH resource pool.

The PUCCH resource pool may be determined by using one or more resource pools in a resource pool 1 to a resource pool 3 (when a plurality of resource pools are involved, a union set of MATH resource sets corresponding to the plurality of resource pools is obtained):

resource pool 1: a PUCCH resource in a PUCCH resource set configured for dynamic scheduling HARQ-ACK feedback;

resource pool 2: a PUCCH resource or a PUCCH resource list independently configured for transmission of a HARQ-ACK that includes only an SPS HARQ-ACK (that is, SPS HARQ-ACK only), including a single PUCCH resource (corresponding to PUCCH format 0/1) configured by the parameter n1PUCCH-AN in SPS-Config and a PUCCH resource list configured by the parameter sps-PUCCH-AN-List-r16 in PUCCH-Config; and

resource pool 3: an independently configured PUCCH resource that can be used for SPS HARQ-ACK feedback (including the delayed SPS HARQ-ACK), where the PUCCH resource may appear periodically.

It should be noted that, based on the current protocol, when the SPS HARQ-ACK is independently transmitted (that is, SPS HARQ-ACK only), the PUCCH resource in the resource pool 2 is used. When the SPS HARQ-ACK is multiplexed with a dynamic scheduling HARQ-ACK, the PUCCH resource in the resource pool 1 is used. However, when the PUCCH resource pool is a union set of the resource pool 1 and the resource pool 2 herein, it may be understood that even if only the SPS HARQ-ACK is transmitted, the PUCCH resource in the PUCCH resource set corresponding to the resource pool manner 1 may be used.

1.2.2. Select the first PUCCH resource from the PUCCH resource pool.

The foregoing predefined resource requirement may be considered as a basic requirement when a PUCCH resource is selected, and there may be more than one first PUCCH resource meeting the predefined resource requirement in the determined first time unit. In this case, the first PUCCH resource may be determined in any one of the following selection manner 1 to selection manner 3.

Selection manner 1: Select an earliest first PUCCH resource. In this way, a HARQ-ACK feedback delay can be minimized. A time of the first PUCCH resource may be any one of the following:

(a) a start time of the first PUCCH resource; and

(b) an end time of the first PUCCH resource.

Selection manner 2: Select a first PUCCH resource corresponding to a PRI.

This is mainly for a case in which the PUCCH resource pool includes the PUCCH resource in the resource pool 1. The PRI may be a PRI indicated in activation/reactivation DCI. When the PUCCH resource is selected, the resource requirement 1 in the predefined resource requirement can necessarily be met. The resource requirement 3 can be ensured when the PUCCH resource set in the resource pool 1 is selected, and the resource requirement 2 can be ensured when a time unit is determined. To be specific, searching is continuously performed, until a time unit that meets a requirement is found or the SPS HARQ-ACK is discarded because a maximum delay limit is exceeded.

When the SPS HARQ-ACK that needs to be transmitted is corresponding to a plurality of SPS Configs, and at least two SPS Configs in the plurality of SPS Configs are corresponding to different PRIs, the PRI or the PUCCH resource corresponding to the SPS ACK needs to be selected. Any one of the following PRI manner 1 to PRI manner 3 may be used.

PRI manner 1: The PRI is selected based on a serving cell index and/or an SPS Configuration index (SPS Config index).

A PRI corresponding to an SPS Config whose corresponding serving cell index and/or SPS Config index is minimum/maximum/a specified value in the plurality of SPS Configs may be used. For example, a PRI corresponding to an SPS Config corresponding to a minimum SPS Config index and a minimum serving cell index may be used to select a PUCCH resource.

PRI manner 2: The PRI is selected based on a transmission moment of an SPS PDSCH.

A PRI corresponding to an SPS Config corresponding to an SPS PDSCH whose transmission moment is the earliest the latest/a specified value in an SPS PDSCH set corresponding to the SPS HARQ-ACK to be transmitted may be used. The SPS PDSCH transmission moment herein may be a start moment or an end moment of the SPS PDSCH. For example, the first PUCCH resource may be selected by using a PRI corresponding to an SPS Config corresponding to an SPS PDSCH with an earliest start moment.

PRI manner 3: The first PUCCH resource is selected based on a PUCCH resource capacity.

A PUCCH resource corresponding to each PRI may be determined based on a plurality of PRIs corresponding to the plurality of SPS Configs, to obtain a PUCCH resource subset. A PUCCH resource whose capacity is minimum/maximum/a specified value in the PUCCH resource subset or a PUCCH resource that best matches a quantity of SPS HARQ-ACK bits to be transmitted (for example, an absolute value of a difference between the two is the smallest) is selected.

It may be understood that when the SPS HARQ-ACK is multiplexed with a dynamic scheduling HARQ-ACK, a PRI indicated by dynamic scheduling may be used to determine the PUCCH resource. For example, a PRI indicated in the last dynamic scheduling DCI corresponding to a HARQ-ACK codebook obtained through multiplexing is used to determine the PUCCH resource.

Selection manner 3: Select a first PUCCH resource that can carry a largest quantity of bits.

For factors that need to be considered in determining the quantity of bits that can be carried in the first PUCCH resource, refer to corresponding descriptions in the resource requirement 3.

2. Processing in a case that resource determining fails

Based on the foregoing corresponding solutions, the terminal may not successfully determine the first PUCCH resource. For example, UE may not successfully select a time unit that meets one or more specified conditions, or a first PUCCH resource that is corresponding to a PRI and that meets the predefined resource requirement does not exist in a selected time unit.

When the UE cannot successfully determine the first PUCCH resource, either of the following processing manner 1 and processing manner 2 may be used.

Processing manner 1: A network side subsequently triggers SPS HARQ-ACK retransmission.

In this case, it may be considered that a solution in which a HARQ-ACK feedback is delayed to a next available PUCCH cannot be used. The delayed SPS HARQ-ACK may be discarded by the network, or the network may trigger retransmission corresponding to the SPS HARQ-ACK according to a requirement based on dynamic signaling or the like. For example, the network side indicates, based on DCI, the UE to retransmit a part or all of the delayed SPS HARQ-ACK by using a type-3 codebook or an enhanced/optimized type-3 codebook.

Processing manner 2: The UE compresses the delayed SPS HARQ-ACK or discards a part of the SPS HARQ-ACK.

The UE may use a bundling manner for a part or all of the delayed SPS HARQ-ACK to compress a quantity of HARQ-ACK bits that actually need to be transmitted, or may discard a part of the delayed SPS HARQ-ACK (for example, a discarding rule may be determined based on a delay time or an SPS Config index) to reduce a quantity of HARQ-ACK bits that actually need to be transmitted, and a PUCCH resource is redetermined based on a quantity of remaining to-be-transmitted HARQ-ACK bits obtained after the compression or discarding operation. The PUCCH resource redetermining operation herein may be for only the last one or more time units within an allowed delay time range, or may be for each time unit within an allowed delay time range.

The following describes a first PUCCH resource determining procedure.

Step 1: For a current delayed SPS HARQ-ACK, determine whether a current time unit meets the slot condition 2; and if the current time unit meets the slot condition 2, perform step 2; otherwise, if it is determined that the slot condition 2 cannot be met subsequently (for example, when the timing requirement 1 is considered and the time unit offset exceeds the predefined maximum value, or when the timing requirement 2 is considered and all values in the predefined set are tried but none meets a requirement), exit the current procedure. The foregoing failure processing related operation may be applied. Otherwise, step 1 is further performed in a next time unit. It should be noted that the slot condition 3 is reflected in a process of searching for a time unit that meets another slot condition, and does not need to be considered separately.

Step 2: Determine a quantity of bits of a HARQ-ACK that needs to be transmitted in the current time unit, where a delayed SPS HARQ-ACK, an SPS HARQ-ACK that needs to be fed back in the current time unit based on timing, a dynamic scheduling HARQ-ACK feedback, and the like may be included.

Step 3: Determine a PUCCH resource pool based on a HARQ-ACK hit that needs to be transmitted (which is an output in step 2, and mainly relates to a quantity of HARQ-ACK bits, downlink transmission/indication corresponding to the HARQ-ACK, and the like). Whether one to more PUCCH resources that meet a predefined resource requirement exist is determined based on each PUCCH resource in the PUCCH resource pool in the current time unit, and whether the current time unit meets the slot condition 1 is also determined. When it is determined that one or more PUCCH resources that meet the predefined resource requirement exist in the current time unit (in this case, the current time unit also meets the slot condition 1), the first PUCCH resource is selected in a specific selection manner, to transmit HARQ-ACK information. Otherwise, step 1 continues to be performed. When the selection manner 2 is used, and a first PUCCH resource corresponding to a PRI does not exist, it may be considered that an error case (which needs to be avoided based on an implementation) occurs, or step 1 may continue to be performed.

After the first PUCCH resource is determined in step 3, a HARQ-ACK codebook constructed based on a HARQ-ACK codebook construction solution described below may be carried in the determined first PUCCH resource.

It should be noted that a construction moment of the HARQ-ACK codebook may be explicitly specified, or may be determined based on an implementation of the terminal. For example, a corresponding HARQ-ACK codebook may be constructed when the quantity of HARQ-ACK bits is determined in step 2, or a corresponding HARQ-ACK codebook may be constructed after the first PUCCH resource is determined in step 3 to avoid unnecessary HARQ-ACK codebook construction. When the determined first PUCCH resource overlaps a PUSCH or PUCCH, various multiplexing rules in the existing specification may be further applied.

As an example, the foregoing first PUCCH resource determining procedure first determines a simple condition of the time unit, and then determines/selects the first PUCCH resource that meets a requirement in the time unit, to reduce complexity of the terminal.

In some embodiments, the first PUCCH resource that meets the requirement may be first determined based on the HARQ-ACK bits in a time unit (for example, the foregoing step 2 and step 3 are performed first), and then whether the time unit meets a corresponding condition is determined (for example, the foregoing step 1 is performed). If the corresponding condition is not met, the corresponding operation is continued for a next time unit, until a combination of a first time unit and a first PUCCH resource that meet the requirement/condition is found. In some alternative embodiments, searching cannot be continued, the determining procedure is exited, and a failure processing related operation is performed.

3. HARQ-ACK codebook construction

Based on the HARQ-ACK bits to be transmitted (including PDSCH transmission types corresponding to these HARQ-ACK bits), codebook categories are distinguished and described as follows.

(1) Category 0: SPS HARQ-ACK only

Codebook construction may follow an existing codebook construction procedure, that is, codebook construction may be performed in a three-layer loop: serving cell—SPS Configuration index (Config index)—Downlink slot slot) (that is, SPS PDSCH). Each DL slot/SPS PDSCH corresponding to an SPS Config index of a serving cell is first traversed, then each SPS Config index of a serving cell is traversed, and finally each serving cell configured for a terminal is traversed. It should be noted that, in this case, a cyclic range of the SPS PDSCH is extended, and is not limited to an SPS PDSCH that is corresponding to an SPS Config and whose end moment falls within a same UL slot (corresponding to a time unit n in HARQ timing), but all delayed HARQ-ACK feedbacks (the foregoing slot condition 2 is still met) of this SPS Config and an SPS HARQ-ACK that needs to be fed back in the determined time unit based on timing (time unit n+k) need to be considered.

In some embodiments, a cyclic order of the three dimensions: serving cell, SPS Config index, and DL slot, may be adjusted, and a loop at each layer is performed in another order. For example, a three-layer loop: serving cell—DL slot—SPS Config index, may be performed. An SPS PDSCH corresponding to each SPS Config index of a serving cell in a DL slot is first traversed (or one or more SPS PDSCHs corresponding to each SPS Config index in the DL slot are traversed according to a start/end moment of the SPS PDSCH), then each DL slot of an SPS PDSCH with a to-be-fed-back HARQ-ACK in a serving cell is traversed, and finally each serving cell configured for UE is traversed.

(2) Category 1: type-1 codebook (Type-1 codebook)

A consideration may be made with reference to the foregoing slot condition 2. Based on a K1 set on which type-1 codebook construction depends, the following codebook solution 1 and codebook solution 2 may be distinguished.

2.1, Codebook solution 1: always depending on a base K1 set

in this case, type-1 codebook construction and a correspondence between each HARQ-ACK bit and a candidate PDSCH reception in a codebook (the codebook herein refers to a HARQ-ACK bit sequence determined according to a predefined pseudo code procedure, which is the same below) are determined according to a predefined rule. For example, the codebook includes HARQ-ACK bits corresponding to any SUN that can be scheduled by the network side for any K1 in the base K1 set, these HARQ-ACK bits are cascaded into a HARQ-ACK bit sequence based on a predefined pseudo code procedure, and a correspondence between each HARQ-ACK bit and a candidate PDSCH reception is determined. When an SPS PDSCH corresponding to a delayed SPS HARQ-ACK has no corresponding HARQ-ACK bit in the codebook, the following codebook manner 1-1 or codebook manner 1-2 may be used.

(a) Codebook manner 1-1: A corresponding SPS HARQ-ACK bit sequence is added to a specified location of the codebook, for example, a header or a tail, and each HARQ-ACK bit in the sequence is in a one-to-one correspondence with an SPS PDSCH having no corresponding HARQ-ACK bit in the codebook. For a specific construction procedure of the added SPS HARQ-ACK bit sequence, refer to the construction procedure in category 0, but SPS PDSCHs having corresponding HARQ-ACK bits in the codebook may be skipped.

This manner may not guarantee a characteristic of a semi-static codebook size, because a length of the added HARQ-ACK bit sequence may vary with a quantity of delayed. SPS HARQ-ACK bits and a correspondence between an SPS PDSCH of a delayed HARQ-ACK feedback and a candidate PDSCH reception in the Codebook. Therefore, a quantity of all to-be-fed-back HARQ-ACK bits is unstable, and there may be a risk of inconsistent understanding of the quantity of fed-back HARQ-ACK bits on both sides (when the rule 2 is used for the resource requirement 2 and a downlink control information format 2_0 (DCI format 2_0) carrying a dynamic SFI is missed in detection on a terminal side).

(b) Codebook manner 1-2: X bits are added to a specified location of the codebook, for example, a header or a tail, to store a HARQ-ACK corresponding to an SPS PDSCH having no corresponding HARQ-ACK bit in the codebook. X may be semi-statically configured by using higher layer signaling or specified in a protocol.

For occupation of the X bits, refer to setting of the HARQ-ACK bit sequence (it is assumed that there are Y bits) added in the codebook manner 1-1. When X>=Y, a correspondence between first Y bits in the X bits and SPS PDSCHs and values of the first Y bits are exactly the same as those of the HARQ-ACK bit sequence added in the codebook manner 1-1. The last X-Y: bits may be set to a default value, for example, LACK. When X<Y, a correspondence between the X bits and SPS PDSCHs and values of the X bits are exactly the same as those of first X bits of the HARQ-ACK bit sequence added in the codebook manner 1-1. In this case, Y—X bits of the SPS HARQ-ACK are discarded, and X and Y are natural numbers.

In some embodiments, when determining X, the UE expects to avoid a case that the SPS HARQ-ACK is discarded (which is avoided on the network side during configuration).

2.2. Codebook solution 2: extended K1 set

With reference to the foregoing predefined timing requirement, a K1 set on which type-1 codebook construction depends is extended relative to a base K1 set. Because a type-1 codebook needs to be constructed only when an SPS HARQ-ACK is multiplexed with a dynamic scheduling HARQ-ACK, the K1 set on which type-1 codebook construction depends necessarily includes all values in the base K1 set, to avoid impact on dynamic scheduling.

In some embodiments, the codebook solution 2 includes a codebook manner 2-1 and a codebook manner 2-2.

(a) Codebook manner 2-1: An extension status of the K1 set is determined based on each type-1 codebook moment (K1 used by the SPS HARQ-ACK is indicated by activation/reactivation DCI), that is, values of K1 corresponding to all SPS HARQ-ACKs pointing to a slot in which a type-1 codebook is reported are determined, a union set of the values of K1 and the base K1 set is obtained and ordered in a predefined manner, and a Rel-15 type-1 codebook construction procedure is followed based on an ordered K1 union set.

The predefined ordering manner herein may be arrangement in descending order from small to large, or may be another arrangement manner.

(b) Codebook manner 2-2: Determine, based on higher layer signaling or protocol regulations, a K1 set on which type-1 codebook construction depends. Either of the following codebook manner 2-2-1 and codebook manner 2-2-2 may be further used.

Codebook manner 2-2-1: A union set of a K1 set used for SPS HARQ-ACK configuration (refer to various manners in the foregoing predefined set) and a base K1 set is obtained (if the K1 set used for SPS HARQ-ACK configuration is the base K1 set, or the union set has been obtained based on the base K1 set, no union set needs to be obtained herein) and ordered in a predefined manner, and an existing type-1 codebook construction procedure is followed based on an ordered K1 union set.

The predefined ordering manner herein may be arrangement in descending order from small to large, or may be another arrangement manner.

Codebook manner 2-2-2: A K1 set is extended to including all natural numbers in 0 to a maximum value of K1, ordering is performed in a predefined manner, and an existing type-1 codebook construction procedure is followed based on an ordered extended K1 set.

The predefined ordering manner herein may be arrangement in descending order from small to large, or may be another arrangement manner. The maximum value of K1 herein may be a larger value in the foregoing predefined maximum value and a maximum value in the base K1 set. Herein, it is mainly considered that a plurality of SPS Configs may be configured for single UE, and a shortest cycle of each SPS Config may be a single slot. In this case, an SPS PDSCH may exist in each (downlink) slot, or an SPS HARQ-ACK that needs to be fed back may exist in each (uplink) slot.

In some embodiments, to avoid addition of HARQ-ACK bits to the type-1 codebook caused due to K1 set extension, the type-1 codebook is constructed based on the extended K1 set only when a delayed SPS HARQ-ACK needs to be multiplexed in a type-1 codebook. Otherwise, the type-1 codebook is constructed based on only a base K1 set configured by a higher layer.

It may be understood that when the delayed SPS HARQ-ACK is corresponding to specific K1 (which is K1 in the base K1 set for the codebook solution 1 and is K1 in the extended K1 set for the codebook solution 2) in the type-1 codebook construction procedure, a candidate PDSCH reception corresponding to the delayed SPS HARQ-ACK meets both (a) and (b).

(a) Corresponding K1 is an offset between a slot to which an SPS PDSCH end moment belongs and a feedback slot of the type-1 codebook.

(b) A corresponding SLIV is a SLIV of the SPS PDSCH.

(3) Category 2: type-2 codebook (Type-2 codebook)

An SPS HARQ-ACK sequence at the tail of the codebook needs to include a HARQ-ACK that is delayed by each SPS Config to the current time unit. For details, refer to the operation in category 0.

In addition, processing of an enhanced dynamic codebook is similar to processing of the type-2 codebook, and details are not described herein again.

In embodiments of this application, an SPS HARQ-ACK discarded due to a symbol conflict in a TDD system is transmitted by using an available PUCCH resource, to ensure smooth functioning of each related link in the system, thereby ensuring overall system performance.

As shown in FIG. 4, an embodiment of this application provides an SPS HARQ-ACK processing apparatus, and the apparatus 400 includes:

a first determining module 401, configured to determine whether a first physical uplink control channel PUCCH resource exists; and

a first sending module 402, configured to send a first SPS HARQ-ACK based on the first PUCCH resource if the first PUCCH resource exists, where the first SPS HARQ-ACK includes at least a delayed SPS HARQ-ACK.

In this embodiment of this application, the first PUCCH resource is in a first time unit.

The first time unit meets one or more of the following:

a first condition, where the first condition includes: the first PUCCH resource meeting a predefined resource requirement exists in the first time unit;

a second condition, where the second condition includes: an offset between the first time unit and a time unit to which a semi-persistent scheduling physical downlink shared channel SPS PDSCH transmission end moment belongs meets a predefined timing requirement; and

a third condition, where the third condition includes: the first time unit is an earliest time unit in a set of time units meeting the first condition and/or the second condition.

In this embodiment of this application, the apparatus 400 further includes a first processing module, configured to: if the first PUCCH resource does not exist, retransmit the first SPS HARQ-ACK, or compress or discard the delayed SPS HARQ-ACK.

In this embodiment of this application, the first processing module is further configured to receive a first indication; and retransmit the first SPS HARQ-ACK according to the first indication.

In this embodiment of this application, the first processing module is further configured to compress a quantity of bits of the delayed SPS HARQ-ACK, or discard a part of the delayed SPS HARQ-ACK, to obtain a second SPS HARQ-ACK; determine a second PUCCH resource based on a quantity of bits of the second SPS HARQ-ACK, and transmit the second SPS HARQ-ACK based on the second PUCCH resource.

In this embodiment of this application, the apparatus 400 further includes a second processing module, configured to determine whether an offset between a second time unit and a time unit to which an SPS PDSCH transmission end moment belongs meets a predefined timing requirement, if the offset meets the predefined timing requirement, determine an SPS HARQ-ACK transmitted in the second time unit; determine a PUCCH resource pool based on the SPS HARQ-ACK transmitted in the second time unit; and select, from the PUCCH resource pool, the first PUCCH resource meeting a predefined resource requirement, and then trigger the first sending module 402 to perform the step of sending the first SPS HARQ-ACK based on the first PUCCH resource.

In this embodiment of this application, the apparatus 400 further includes a third processing module, configured to determine a PUCCH resource pool based on an SPS HARQ-ACK transmitted in a third time unit; select, from the PUCCH resource pool, the first PUCCH resource meeting a predefined resource requirement; determine whether an offset between the third time unit and a time unit to which an SPS PDSCH transmission end moment belongs meets a predefined timing requirement; and if the offset meets the predefined timing requirement, trigger the first sending module 402 to perform the step of sending the first SPS HARQ-ACK based on the first PUCCH resource.

In this embodiment of this application, the predefined timing requirement includes one or more of the following:

the offset of the first time unit does not exceed a predefined maximum value; and

the offset of the first time unit is a specific value in a predefined set.

In this embodiment of this application, the predefined maximum value includes any one of the following:

a maximum value of K1 in a base K1 set configured by a higher layer;

a TDD cycle length corresponding to a TDD pattern configured by a higher layer;

a parameter independently configured by a higher layer; and

a value specified in a protocol.

In this embodiment of this application, the predefined set includes any one of the following:

a base K1 set;

a new K1 set independently configured by a higher layer for the delayed SPS HARQ-ACK,

a union set of a base K1 set and an additional K1 set that is additionally configured by a higher layer for the delayed SPS HARQ-ACK; and

a set specified in a protocol.

In this embodiment of this application, the predefined resource requirement includes one or more of the following:

the first PUCCH resource is in a first PUCCH resource pool;

a time domain and/or a frequency domain occupied by the first PUCCH resource are/is available; and

the first PUCCH resource can carry a quantity of bits of a HARQ-ACK that needs to be transmitted in a current time unit,

In this embodiment of this application, the first PUCCH resource pool includes one or more of the following:

a PUCCH resource in a PUCCH resource set configured for dynamic scheduling HARQ-ACK feedback;

a PUCCH resource configured for transmission of a HARQ-ACK that comprises only an SPS HARQ-ACK; and

a configured PUCCH resource that can be used for SPS HARQ-ACK feedback.

In this embodiment of this application, whether the time domain and/or the frequency domain occupied by the first PUCCH resource are/is available is determined based on one or more of the following:

an semi-static configuration;

a slot format indication for dynamic indication; and

downlink control information.

In this embodiment of this application, if there are a plurality of PUCCH resources meeting the predefined resource requirement in the first time unit, the first PUCCH resource is determined in any one of the following manners:

the first PUCCH resource is a PUCCH resource with an earliest start time or end time;

the first PUCCH resource is a PUCCH resource corresponding to a first physical uplink control channel resource indicator PRI, and the first PRI is a PRI corresponding to the first SPS HARQ-ACK; and

the first PUCCH resource is a PUCCH resource that can carry a largest quantity of bits.

In this embodiment of this application, when the first SPS HARQ-ACK corresponds to a plurality of PRIs, the first PRI is determined based on one or more of the following:

a serving cell index;

an SPS configuration index;

an SPS PDSCH transmission moment; and

a PUCCH resource capacity.

In this embodiment of this application, a category of a codebook including the first SPS HARQ-ACK corresponds to any one of the following:

a codebook including only an SPS HARQ-ACK;

a type-1 codebook; and

a type-2 codebook.

In this embodiment of this application, a manner for constructing the codebook applicable to only the SPS HARQ-ACK includes:

performing a loop at each layer on a serving cell, an SPS configuration index, and a downlink slot in a preset order.

In this embodiment of this application, a manner for constructing the type-1 codebook includes one of the following:

construction based on a base K1 set; and

construction based on an extended K1 set.

In this embodiment of this application, the construction based on a base K1 set includes one of the following:

adding a corresponding SPS HARQ-ACK bit sequence to a specified location of a codebook, where each HARQ-ACK bit in the SPS HARQ-ACK bit sequence is in a one-to-one correspondence with a first SPS PDSCH, and no HARQ-ACK bit corresponding to the first SPS PDSCH exists in the codebook; and

adding X bits to a specified location of a codebook, where the X bits are used to store a HARQ-ACK corresponding to a first SPS PDSCH, no HARQ-ACK bit corresponding to the first SPS PDSCH exists in the codebook, that is, the HARQ-ACK corresponding to the first SPS PDSCH has no corresponding HARQ-ACK bit in the codebook, and X is a positive integer.

In this embodiment of this application, the construction based on an extended K1 set includes one of the following:

determining values of K1 corresponding to all SPS HARQ-ACKs that point to a time unit in which a specified type-1 codebook is reported, obtaining and ordering a union set of the values of K1 and a base K1 set, and then constructing a codebook based on an ordered union set;

obtaining and ordering a union set of a K1 set used for SPS HARQ-ACK configuration and a base K1 set, and then constructing a codebook based on an ordered union set;

constructing a codebook based on a K1 set used for SPS HARQ-ACK configuration; and

setting a first K1 set to comprising all natural numbers in 0 to a maximum value of K1, performing ordering, and constructing a codebook based on the first K1 set, wherein the maximum value of K1 is a maximum value in the base K1 set.

In this embodiment of this application, the delayed SPS HARQ-ACK corresponds to a first candidate PDSCH reception in the type-1 codebook, and the first candidate PDSCH reception meets:

corresponding K1 is an offset between a time unit to which an end moment of a second SPS PDSCH belongs and a feedback time unit of the type-1 codebook; and

a corresponding start and length indicator value SLIV is a SLIV corresponding to the second SPS PDSCH.

The second SPS PDSCH corresponds to the delayed SPS HARQ-ACK.

The apparatus provided in this embodiment of this application can implement processes implemented in the method embodiment shown in FIG. 4, and achieve a same technical effect. To avoid repetition, details are not described herein again.

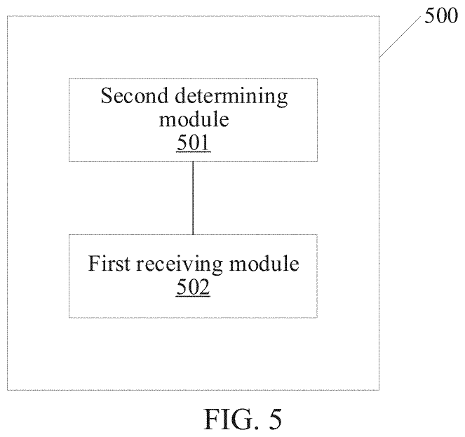

As shown in FIG. 5, an embodiment of this application provides an SPS HARQ-ACK processing apparatus, and the apparatus 500 includes:

a second determining module 501, configured to determine whether a first PUCCH resource exists; and

a first receiving module 502, configured to receive a first SPS HARQ-ACK based on the first PUCCH resource if the first PUCCH resource exists, where the first SPS HARQ-ACK includes at least a delayed SPS HARQ-ACK.

In this embodiment of this application, the apparatus 500 further includes:

a second sending module, configured to send a first indication, where the first indication is used to indicate a terminal to retransmit the first SPS HARQ-ACK.

In this embodiment of this application, the first PUCCH resource is in a first time unit.

The first time unit meets one or more of the following:

a first condition, where the first condition includes: the first PUCCH resource meeting a predefined resource requirement exists in the first time unit;

a second condition, where the second condition includes: an offset between the first time unit and a time unit to which a semi-persistent scheduling physical downlink shared channel SPS PDSCH transmission end moment belongs meets a predefined timing requirement; and

a third condition, where the third condition includes: the first time unit is an earliest time unit in a set of time units meeting the first condition and/or the second condition.

In this embodiment of this application, the predefined timing requirement includes one or more of the following:

the offset of the first time unit does not exceed a predefined maximum value; and

the offset of the first time unit is a specific value in a predefined set.

In this embodiment of this application, the predefined maximum value includes any one of the following:

a maximum value of K1 in a base K1 set configured by a higher layer;

a TDD cycle length corresponding to a time division duplex TDD pattern Pattern configured by a higher layer;

a parameter independently configured by a higher layer; and

a value specified in a protocol.

In this embodiment of this application, the predefined set includes any one of the following:

a base K1 set;

a new K1 set independently configured by a higher layer for the delayed SPS HARQ-ACK;

a union set of a base K1 set and an additional K1 set that is additionally configured by a higher layer for the delayed SPS HARQ-ACK; and

a set specified in a protocol.

In this embodiment of this application, the predefined resource requirement includes one or more of the following:

the first PUCCH resource is in a first PUCCH resource pool;

a time domain and/or a frequency domain occupied by the first PUCCH resource are/is available; and

the first PUCCH resource can carry a quantity of bits of a HARQ-ACK that needs to be transmitted in a current time unit.

In this embodiment of this application, the first PUCCH resource pool includes one or more of the following:

a PUCCH resource in a PUCCH resource set configured for dynamic scheduling HARQ-ACK feedback;

a PUCCH resource configured for transmission of a HARQ-ACK that comprises only an SPS HARQ-ACK; and

a configured PUCCH resource that can be used for SPS HARQ-ACK feedback.

In this embodiment of this application, whether the time domain and/or the frequency domain occupied by the first PUCCH resource are/is available is determined based on one or more of the following:

an RRC semi-static configuration;

a slot format indication for dynamic indication; and

downlink control information.

In this embodiment of this application, if there are a plurality of PUCCH resources meeting the predefined resource requirement in the first time unit, the first PUCCH resource is determined in any one of the following manners:

the first PUCCH resource is a PUCCH resource with an earliest start time or end time;

the first PUCCH resource is a PUCCH resource corresponding to a first PRI, and the first PRI is a PRI corresponding to the first SPS HARQ-ACK; and

the first PUCCH resource is a PUCCH resource that can carry a largest quantity of bits.

In this embodiment of this application, when the first SPS HARQ-ACK corresponds to a plurality of PRIs, the first PRI is determined based on one or more of the following:

a serving cell index;

an SPS configuration index;

an SPS PDSCH transmission moment; and

a PUCCH resource capacity.

The apparatus provided in this embodiment of this application can implement processes implemented in the method embodiment shown in FIG. 5, and achieve a same technical effect. To avoid repetition, details are not described herein again.

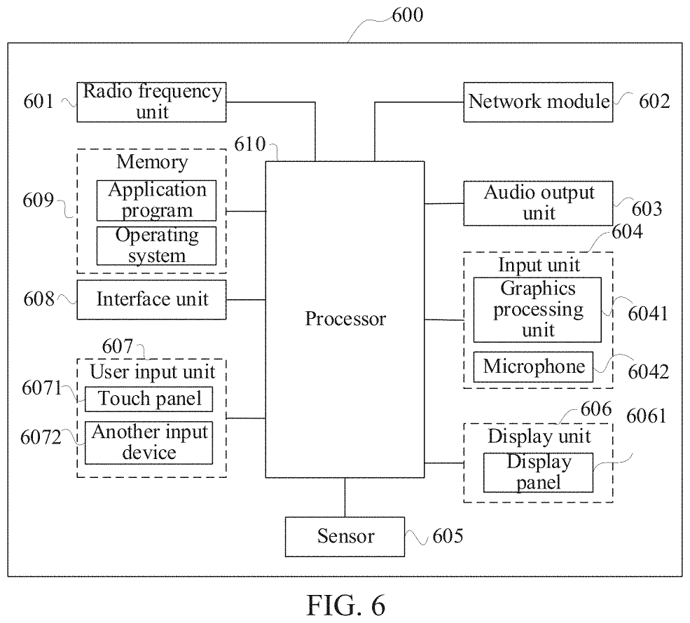

FIG. 6 is a schematic diagram of a hardware structure of a terminal according to an embodiment of this application. The terminal 600 includes but is not limited to components such as a radio frequency unit 601; a network module 602, an audio output unit 603, an input unit 604, a sensor 605, a display unit 606, a user input unit 607, an interface unit 608, a memory 609, and a processor 610.

A person skilled in the art may understand that the terminal 600 may further include a power supply (for example, a battery) that supplies power to each component, and the power supply may be logically connected to the processor 610 by using a power management system, to implement functions such as charging management, discharging management, and power consumption management by using the power management system. The structure of the terminal shown in FIG. 6 does not constitute a limitation on the terminal. The terminal may include more or fewer components than those shown in the figure, or combine some components, or have different component arrangements. Details are not described herein again.

should be understood that in this embodiment of this application, the input unit 604 may include a Graphics Processing Unit GPU 6041 and a microphone 6042. The GPU 6041 processes image data of a static picture or a video obtained by an image capture apparatus (such as a camera) in a video capture mode or an image capture mode. The display unit 606 may include a display panel 6061, and the display panel 6061 may be configured in a form of a liquid crystal display, an organic light-emitting, diode, or the like. The user input unit 607 includes a touch panel 6071 and another input device 6072. The touch panel 6071 is also referred to as a touchscreen. The touch panel 6071 may include two parts: a touch detection apparatus and a touch controller. The another input device 6072 may include but is not limited to a physical keyboard, a function button (such as a volume control button or a power button), a trackball, a mouse, and an operating lever. Details are not described herein.

In this embodiment of this application, after receiving downlink data from a network side device, the radio frequency unit 601 sends the downlink data to the processor 610 for processing. In addition, the radio frequency unit 601 sends uplink data to the network side device. Generally, the radio frequency unit 601 includes but is not limited to an antenna, at least one amplifier, a transceiver, a coupler, a low-noise amplifier, a duplexes, or the like.

The memory 609 may be configured to store a software program or instruction and various types of data. The memory 609 may mainly include a program or instruction storage area and a data storage area. The program or instruction storage area may store an operating system, an application program or an instruction required by at least one function (such as a sound play function or an image play function), and the like. In addition, the memory 609 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory, for example, at least one magnetic disk storage device, a flash memory device, or another non-volatile solid-state storage device.

The processor 610 may include one or more processing units. In some embodiments, the processor 610 may be integrated with an application processor and a modem processor. The application processor mainly processes an operating system, a user interface, an application program or an instruction, and the like, and the modem processor mainly processes wireless communication, such as a baseband processor. It may be understood that the modem processor may not be integrated into the processor 610.

The terminal provided in this embodiment of this application can implement processes implemented in the method embodiment shown in FIG. 2, and achieve a same technical effect. To avoid repetition, details are not described herein again.

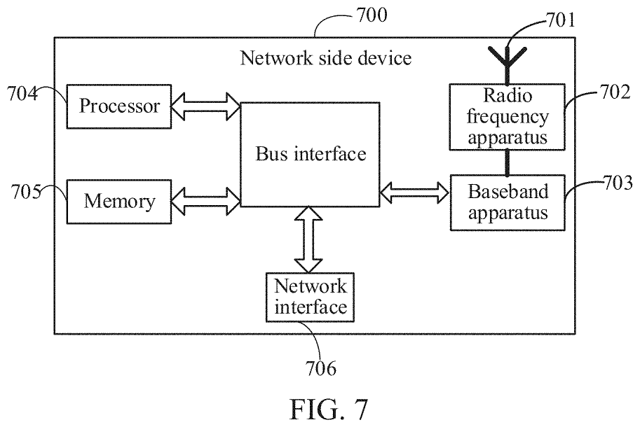

An embodiment of this application further provides a network side device. As shown in FIG. 7, the network side device 700 includes an antenna 701, a radio frequency apparatus 702, and a baseband apparatus 703. The antenna 701 is connected to the radio frequency apparatus 702. In an uplink direction, the radio frequency apparatus 702 receives information by using the antenna 701, and sends the received information to the baseband apparatus 703 for processing. In a downlink direction, the baseband apparatus 703 processes to-be-sent information, and sends the to-be-sent information to the radio frequency apparatus 702. After processing the received information, the radio frequency apparatus 702 sends the information by using the antenna 701.

The foregoing band processing apparatus may be located in the baseband apparatus 703. In the foregoing embodiment, a method performed by the network side device may be implemented in the baseband apparatus 703. The baseband apparatus 703 includes a processor 704 and a memory 705.

For example, the baseband apparatus 703 may include at least one baseband board. A plurality of chips are disposed on the baseband board. As shown in FIG. 7, one chip is, for example, the processor 704, connected to the memory 705, to invoke a program in the memory 705 to perform an operation of the network device shown in the foregoing method embodiments.

The baseband apparatus 703 may further include a network interface 706, configured to exchange information with the radio frequency apparatus 702. The interface is, for example, a Common Public Radio Interface (CPRI).

For example, the network side device in this embodiment of this application further includes an instruction or a program that is stored in the memory 705 and that can be run on the processor 704. The processor 704 invokes the instruction or the program in the memory 705 to perform the method performed by the modules in FIG. 5, and achieve a same technical effect. To avoid repetition, details are not described herein again.

An embodiment of this application further provides a program product. The program product is stored in a non-volatile storage medium, and the program product is executed by at least one processor to implement the steps of the processing method described in FIG. 2.

An embodiment of this application further provides a readable storage medium. The readable storage medium stores a program or an instruction. When the program or the instruction is executed by a processor, processes in the method embodiment shown in FIG. 2 are implemented, and a same technical effect can be achieved. To avoid repetition, details are not described herein again.

The processor is a processor in the terminal in the foregoing embodiment. The readable storage medium includes a computer-readable storage medium, such as an ROM, a Random Access Memory (RAM), a magnetic disk, or an optical disc.

An embodiment of this application further provides a chip. The chip includes a processor and a communication interface, the communication interface is coupled to the processor, and the processor is configured to run a program or an instruction on a network side device to implement processes of the foregoing method embodiment shown in FIG. 2, and can achieve a same technical effect. To avoid repetition, details are not described herein again.

An embodiment of this application provides a computer program product. The program product is stored in a non-volatile storage medium. The program product is executed by at least one processor to implement processes in the foregoing method embodiments, and a same technical effect can be achieved. To avoid repetition, details are not described herein again.

An embodiment of this application provides a communication device, which is configured to perform processes in the foregoing method embodiments, and can achieve a same technical effect. To avoid repetition, details are not described herein again.

It should be understood that the chip mentioned in embodiments of this application may also be referred to as a system-level chip, a system chip, a chip system, a system-on-a-chip, or the like.

It should be noted that, in this specification, the term “include”, “have”, or any other variant thereof is intended to cover non-exclusive inclusion, so that a process, method, article, or apparatus that includes a series of elements includes not only those elements but also other elements that are not explicitly listed, or includes elements inherent to such a process, method, article, or apparatus. In a case without more restrictions, for an element limited by the statement “include a . . . ”, a process, method, article, or apparatus that includes the element may further include another same element. In addition, it should be noted that the scope of the method and apparatus in embodiments of this application is not limited to performing a function in an order shown or discussed, and may further include performing a function in a basically simultaneous manner or in a reverse order according to a related function. For example, the described method may be performed in a different order, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by using software and a necessary universal hardware platform, or may be implemented by using hardware. In some embodiments, the technical solutions in this application entirely or the part contributing to the conventional technology may be implemented in a form of a software product. The computer software product is stored in a storage medium (such as a ROM/RAM, a magnetic disk, or an optical disc), and includes several instructions for instructing a terminal (which may be a mobile phone, a computer, a server, an air conditioner, or a network device) to perform the method described in embodiments of this application.

Embodiments of this application are described above with reference to the accompanying drawings. However, this application is not limited to the foregoing specific implementations. The foregoing specific implementations are merely an example but not a limitation. Many forms that can be made by a person of ordinary skill in the art without departing from the principle of this application and the protection scope of the claims fall within the protection scope of this application.

What is claimed is:

1. A Semi-Persistent Scheduling (SPS) Hybrid Automatic Repeat reQuest ACKnowledgement (HARQ-ACK) processing method, performed by a terminal, comprising:
determining whether a first Physical Uplink Control Channel (PUCCH) resource exists; and
sending a first SPS HARQ-ACK based on the first PUCCH resource if the first PUCCH resource exists, wherein the first SPS HARQ-ACK comprises at least a delayed SPS HARQ-ACK,

2. The SPS HARQ-ACK processing method according to claim 1, wherein the first PUCCH resource is in a first time unit, wherein
the first time unit meets one or more of the following:
a first condition, wherein the first condition comprises: the first PUCCH resource meeting a predefined resource requirement exists in the first time unit;
a second condition, wherein the second condition comprises: an offset between the first time unit and a time unit to which a SPS Physical Downlink Shared Channel PDSCH transmission end moment belongs meets a predefined timing requirement; or
a third condition, wherein the third condition comprises: the first time unit is an earliest time unit in a set of time units meeting the first condition or the second condition.

3. The SPS HARQ-ACK processing method according to claim 1, wherein if the first PUCCH resource does not exist, the method further comprises:
retransmitting the first SPS HARQ-ACK, or
compressing or discarding the delayed SPS HARQ-ACK.

4. The SPS HARQ-ACK processing method according to claim 3, wherein the retransmitting the first SPS HARQ-ACK comprises:
receiving a first indication, and
retransmitting the first SPS HARQ-ACK according to the first indication; or
wherein the compressing or discarding the delayed SPS HARQ-ACK comprises:
compressing a quantity of bits of the delayed SPS HARQ-ACK, or discarding a part of the delayed SPS HARQ-ACK, to obtain a second SPS HARQ-ACK;
determining a second PUCCH resource based on a quantity of bits of the second SPS HARQ-ACK; and
transmitting the second SPS HARQ-ACK based on the second PUCCH resource.

5. The SPS HARQ-ACK processing method according to claim 1, further comprising:
determining whether an offset between a second time unit and a time unit to which an SPS transmission end moment belongs meets a predefined timing requirement;
if the offset meets the predefined timing requirement, determining an SPS HARQ-ACK transmitted in the second time unit;
determining a PUCCH resource pool based on the SPS HARQ-ACK transmitted in the second time unit; and
selecting, from the PUCCH resource pool, the first PUCCH resource meeting a predefined resource requirement, and then performing sending the first SPS HARQ-ACK based on the first PUCCH resource.

6. The SPS HARQ-ACK processing method according to claim 1, further comprising:
determining a PUCCH resource pool based on an SPS HARQ-ACK transmitted in a third time unit;
selecting, from the PUCCH resource pool, the first PUCCH resource meeting a predefined resource requirement;
determining whether an offset between the third time unit and a time unit to which an SPS PDSCH transmission end moment belongs meets a predefined tuning requirement; and
if the offset meets the predefined timing requirement, performing sending the first SPS HARQ-ACK based on the first PUCCH resource.

7. The SPS HARQ-ACK processing method according to claim 2,
wherein:
the predefined timing requirement comprises one or more of the following:
that the offset of the first time unit does not exceed a predefined maximum value; or
that the offset of the first time unit is a specific value in a predefined set; or
the predefined resource requirement comprises one or more of the following:
that the first PUCCH resource is in a first PUCCH resource pool;
that a time domain or a frequency domain occupied by the first PUCCH resource is available; or
the first PUCCH resource can carry a quantity of bits of a HARQ-ACK that needs to be transmitted in a current time unit.

8. The SPS HARQ-ACK processing method according to claim 7,
wherein:
the predefined maximum value comprises any one of the following:
a maximum value of K1 in a base K1 set configured by a higher layer,
a Time Division Duplex (TDD) cycle length corresponding to a TDD pattern configured by a higher layer,
a parameter independently configured by a higher layer; or
a value specified in a protocol; or
the predefined set comprises any one of the following:
a base K1 set,
a new K1 set independently configured by a higher layer for the delayed SPS HARQ-ACK,
a union set of a base K1 set and an additional K1 set that is additionally configured by a higher layer for the delayed SPS HARQ-ACK, or
a set specified in a protocol.

9. The SPS HARQ-ACK processing method according to claim 7, wherein if there are a plurality of PUCCH resources meeting the predefined resource requirement in the first time unit, the first PUCCH resource is determined in any one of the following manners:
that the first PUCCH resource is a PUCCH resource with an earliest start time or end time;
that the first PUCCH resource is a PUCCH resource corresponding to a first PUCCH Resource Indicator (PRI), and the first PRI is a PRI corresponding to the first SPS HARQ-ACK; or
the first PUCCH resource is a PUCCH resource that can carry a largest quantity of bits.

10. The SPS HARQ-ACK processing method according to claim 9, wherein when the first SPS HARQ-ACK corresponds to a plurality of PRIs, the first PRI is determined based on one or more of the following:
a serving cell index;
an SPS configuration index;
an SPS PDSCH transmission moment; or
a PUCCH resource capacity.

11. The SPS HARQ-ACK processing method according to claim 1, wherein a category of a codebook comprising the first SPS HARQ-ACK corresponds to any one of the following:
a codebook comprising only an SPS HARQ-ACK;
a type-1 codebook; or
a type-2 codebook.

12. A Semi-Persistent Scheduling (SPS) Hybrid Automatic Repeat reQuest ACKnowledgement (HARQ-ACK) processing method, performed by a network side device, comprising:
determining whether a first Physical Uplink Control Channel (PUCCH) resource exists; and
receiving a first SPS HARQ-ACK based on the first PUCCH resource if the first PUCCH resource exists, wherein the first SPS HARQ-ACK comprises at least a delayed SPS HARQ-ACK.

13. The SPS HARQ-ACK processing method according to claim 12, wherein further comprising:
sending a first indication, wherein the first indication is used to indicate a terminal to retransmit the first SPS HARQ-ACK.

14. The SPS HARQ-ACK processing method according to claim 12, wherein the first PUCCH resource is in a first time unit, wherein
the first time unit meets one or more of the following:
a first condition, wherein the first condition comprises: that the first PUCCH resource meeting a predefined resource requirement exists in the first time unit;
a second condition, wherein the second condition comprises: that an offset between the first time unit and a time unit to which an SPS Physical Downlink Shared Channel PDSCH transmission end moment belongs meets a predefined timing requirement; or
a third condition, wherein the third condition comprises: that the first time unit is an earliest time unit in a set of time units meeting the first condition or the second condition.

15. The SPS HARQ-ACK processing method according to claim 14, wherein the predefined timing requirement comprises one or more of the following:
that the offset of the first time unit does not exceed a predefined maximum value; or
that the offset of the first time unit is a specific value in a predefined set.

16. The SPS HARQ-ACK processing method according to claim 15, wherein the predefined maximum value comprises any one of the following:
a maximum value of K1 in a base K1 set configured by a higher layer;
a Time Division Duplex (TDD) cycle length corresponding to a TDD pattern configured by a higher layer;
a parameter independently configured by a higher layer; or
a value specified in a protocol.

17. The SPS HARQ-ACK processing method according to claim 15, wherein the predefined set comprises any one of the following:
a base K1 set;
a new K1 set independently configured by a higher layer for the delayed SPS HARQ-ACK;
a union set of a base K1 set and an additional K1 set that is additionally configured by a higher layer for the delayed SPS HARQ-ACK; or
a set specified in a protocol.

18. The SPS HARQ-ACK processing method according to claim 14, wherein the predefined resource requirement comprises one or more of the following:
the first PUCCH resource is in a first PUCCH resource pool;
a time domain or a frequency domain occupied by the first PUCCH resource is available; or
the first PUCCH resource can carry a quantity of bits of a HARQ-ACK that needs to be transmitted in a current time unit.

19. The SPS HARQ-ACK processing method according to claim 18, wherein the first PUCCH resource pool comprises one or more of the following:
a PUCCH resource in a PUCCH resource set configured for dynamic scheduling HARQ-ACK feedback;
a PUCCH resource configured for transmission of a HARQ-ACK that comprises only an SPS HARQ-ACK; or
a configured PUCCH resource that can be used for SPS HARQ-ACK feedback.

20. A terminal, comprising a processor; a memory haying a computer program stored thereon, wherein the computer program, when executed by the processor, causes the processor to perform a Semi-Persistent Scheduling (SPS) Hybrid Automatic Repeat reQuest ACKnowledgement (HARQ-ACK) processing method, comprising:
determining whether a first Physical Uplink Control Channel (PUCCH) resource exists; and
sending a first SPS HARQ-ACK based on the first PUCCH resource if the first PUCCH resource exists, wherein the first SPS HARQ-ACK comprises at least a delayed SPS HARQ-ACK.
